(19) United States
(12) Patent Application Publication
(10) Pub. No.: US 2010/0009745 A1
(43) Pub. Date: Jan. 14, 2010

(54) METHOD AND APPARATUS FOR ENHANCING PLAYER INTERACTION IN CONNECTION WITH A MULTI-PLAYER GAMING TABLE

(76) Inventors: James W. Stockdale, Clio, CA (US); Harold E. Mattice, Gardnerville, NV (US); Chauncey W. Griswold, Reno, NV (US); Richard L. Wilder, Sparks, NV (US); Christian E. Gadda, Las Vegas, NV (US)

Correspondence Address: Armstrong Teasdale LLP (IGT - 26668);Robert B. Reeser, III, One Metropolitan Square, Suite 2600, St. Louis, MO, 63102, US

(21) Appl. No.: 12/170,878

(22) Filed: Jul. 10, 2008

(51) Int. Cl. A63F 13/00

(52) U.S. Cl. 463/31

(57) ABSTRACT

Method and apparatus for use with a gaming table. An apparatus includes a base, a user-actuated wheel coupled to the base such that the wheel is rotatable relative to the base, and a display configured to display an image corresponding to a position of the wheel to a player.

### BACKGROUND OF THE INVENTION

The embodiments described herein relate generally to table games and, more specifically, to a portable gaming apparatus for use at gaming tables.

Casinos and other forms of gaming make up a growing multi-billion dollar industry both domestically and abroad. Within such environments, table games are an immensely popular form of gaming and are a substantial source of revenue for gaming operators. Such table games are well known and may include for example, poker, Blackjack, baccarat, craps, roulette, and other traditional games. Moreover such table games may include more recently introduced games such as Paigow, Caribbean Stud®, Spanish 21, and Let It Ride® (Caribbean Stud is a registered trademark of Mikohn Gaming Corporation of Las Vegas, Nev., and Let It Ride is a registered trademark of Shuffle Master, Inc. of Las Vegas, Nev.). In a typical gaming event at a gaming table, a player places a wager on a game, whereupon a winning may be paid to the player depending on the outcome of the game. As is generally known, a wager may involve the use of cash or one or more chips, markers or the like, as well as various forms of gestures or oral claims. The game itself may involve the use of, for example, one or more cards, dice, wheels, balls, tokens or the like, with the rules of the game and any payouts or pay tables being established prior to game play. As is also known, possible winnings may be paid in cash, credit, one or more chips, markers, or prizes, or by other forms of payouts.

Although standard, fully-manual gaming tables have been around for many years, gaming tables having more “intelligent” features are becoming increasingly popular. For example, many gaming tables now include automatic card shufflers, liquid crystal display (LCD) screens, biometric identifiers, automated chip tracking devices, and even cameras adapted to track chips and/or playing cards, among various other items and devices.

At least some known gaming tables, including both standard gaming tables and electronic gaming tables, include such added items and devices. However, such gaming tables currently lack a reward feature for players that qualify for a bonus round. Accordingly, it is desirable to provide a table top gaming device for use during a bonus round.

### BRIEF DESCRIPTION OF THE INVENTION

In one aspect, a portable gaming device is provided including a base, a user-actuated wheel coupled to the base such that the wheel is rotatable relative to the base, and a display configured to display an image corresponding to a position of the wheel to a player.

In another aspect, a method of game play using a portable gaming device is provided. The method includes presenting the gaming device to a player, rotating a wheel coupled to a stationary base, determining a position of the wheel, and displaying an image to the player corresponding to the position of the wheel.

In another aspect, an apparatus for implementing a wheel-based bonus game is provided. The apparatus includes a base, a wheel coupled to the base such that the wheel is rotatable relative to the base, an indicator for indicating a position of the wheel relative to the base, and a display configured to display an image to a player corresponding to the position of the wheel.

### BRIEF DESCRIPTION OF THE DRAWINGS

The included drawings are for illustrative purposes and serve only to provide examples of possible structures and process steps for the disclosed inventive playing systems and methods for table games. The drawings do not limit any changes in form and detail that may be made to the invention by one skilled in the art without departing from the spirit and scope of the invention.

FIG. 1 is a schematic diagram of an exemplary gaming table;

FIG. 2 is a schematic diagram of an exemplary interactive gaming display table;

FIG. 3 is a side view of an exemplary gaming device that may be used with a gaming table, such as the tables shown in FIG. 1 and FIG. 2;

FIG. 4 is a top view of the device shown in FIG. 3;

FIG. 5 is a top view of another exemplary gaming device that may be used with a gaming table, such as the tables shown in FIGS. 1 and 2; and

FIG. 6 is a flowchart illustrating an exemplary method for implementing a wheel-based game using a gaming device, such as the gaming devices shown in FIGS. 3 and 4.

### DETAILED DESCRIPTION OF THE INVENTION

Exemplary embodiments of apparatus and methods according to the present invention are described herein. The embodiments are provided solely to add context to and to aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following example should not be taken as definitive or limiting either in scope or setting. In the detailed description that follows, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used and changes may be made without departing from the spirit and scope of the invention.

Various advantages of the present invention include the introduction of devices for use with a gaming table that is more fully automated, providing added benefits to the gaming operator, and also having various automated and player-friendly items and functionalities. The devices described herein may be used to, for example, award a bonus game to one or more players.

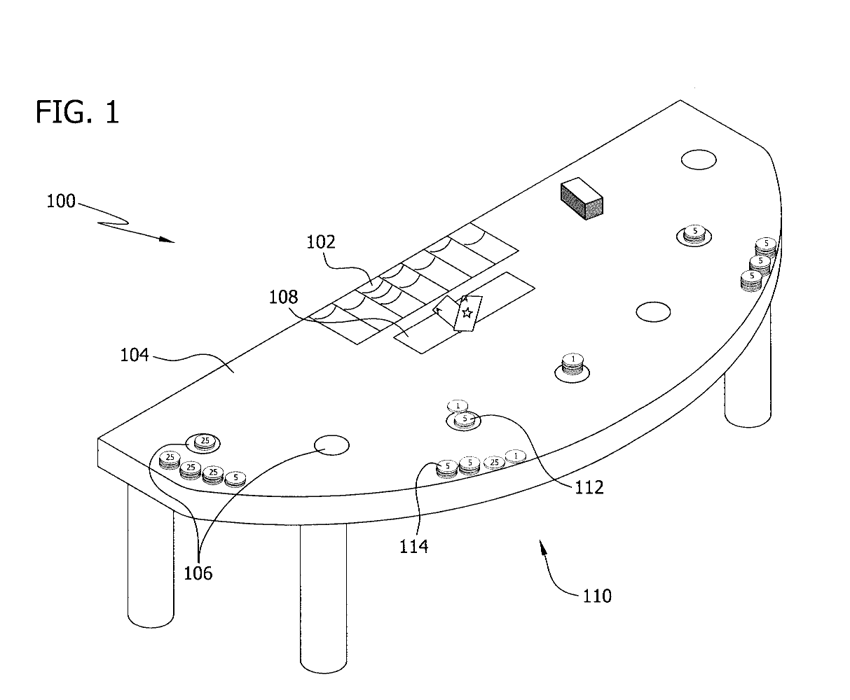

FIG. 1 is a schematic diagram of an exemplary gaming table 100. In the exemplary embodiment, table 100 includes a chip tray 102 that stores gaming chips, and an upper surface 104 that is adapted for game play and/or other transactions involving the gaming chips. A plurality of chip placement areas 106 and 108 are positioned about upper surface 104 with respect to a plurality of player positions 110 and, in some embodiments, may include a bet or wager placement area 106 and/or a cash for chips or other chip conversion area 108. In the exemplary embodiment, gaming chips 112 and 114 of one or more denominations are positioned across upper surface 104 with respect to player positions 110. For example, in the exemplary embodiment, gaming chip 112 is a current wager in bet placement area 106, and gaming chip 114 is not subject to play or action at table 100. In one embodiment, table 100 includes a processor (not shown), such as the processor described below. In an alternative embodiment, the processor may be located at a central location in relation to gaming table 100 and any other gaming tables and/or gaming devices such as those described herein.

Although gaming table 100 is illustrated in FIG. 1 as being a blackjack table, it will be understood that gaming table 100 may be used for other games such as, but not limited to, craps, roulette, poker, and/or a sports book layout.

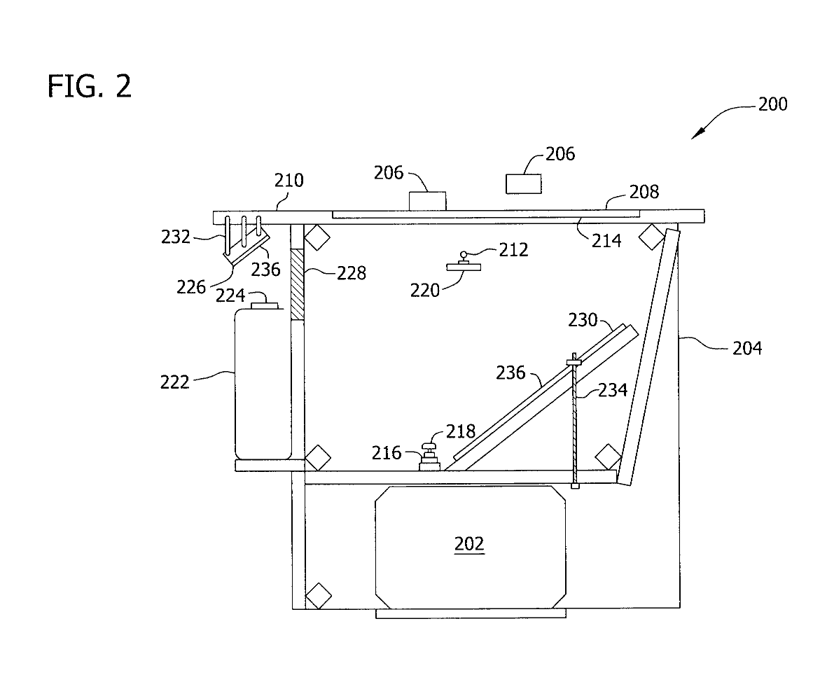

FIG. 2 is a schematic diagram of an exemplary interactive gaming display table 200. In the exemplary embodiment, table 200 includes at least one processor 202 that is enclosed within a frame 204. Moreover, in the exemplary embodiment, table 200 uses infrared (IR) light to interact with tabletop devices, such as a device 206, that are positioned on, or slightly above, a display surface 208 set within an upper surface 210 of table 200.

In one embodiment, one or more IR light sources 212 are coupled to, such as fixedly secured to, frame 204. In the exemplary embodiment, IR light source 212 includes a plurality of light emitting diodes (LEDs) and the light produced by IR light sources 212 is directed upward towards an underside of display surface 208. Infrared light from IR light sources 212 passes through a translucent layer 214 of display surface 208 and is reflected from any tabletop devices, such as device 206, that are positioned on, or near, display surface 208. In the exemplary embodiment, translucent layer 214 is fabricated from a sheet of vellum, or any other suitable translucent material that has light diffusing properties. More specifically, after passing through translucent layer 214, the IR light may exit through display surface 208 without illuminating any tabletop devices 206. Alternatively, the IR light may illuminate one or more tabletop devices 206, that are positioned on display surface 208. Moreover, the IR light may illuminate one or more tabletop devices 206 that are positioned adjacent to, but not touching, display surface 208.

Moreover, in the exemplary embodiment, a digital video camera 216 is coupled to frame 204 below display surface 208. More specifically, video camera 216 is positioned with respect to display surface 208 to facilitate maximizing an amount of IR light reflected from tabletop devices 206 positioned above display surface 208. Video camera 216 includes an IR pass filter 218 that transmits only IR light and prevents ambient visible light from traveling through display surface 208. Because it is desired that video camera 216 produce an output signal representative of only the IR light reflected from tabletop devices 206, a baffle 220 is positioned between IR light source 212 and video camera 216 to substantially prevent IR light that is directly emitted from IR light source 212 from entering video camera 216. As such, IR light reflected from tabletop devices 206 may be reflected through translucent layer 214, through IR pass filter 218, and into video camera 216. Alternatively, IR light reflected from tabletop devices 206 may be reflected or absorbed by other interior surfaces within table 200 without entering video camera 216.

In the exemplary embodiment, translucent layer 214 substantially diffuses both incident and reflected IR light. As such, those tabletop devices 206 positioned above display surface 208, but not in contact with display surface 208, will reflect less IR light back to digital video camera 216 than those tabletop devices 206 positioned in contact with display surface 208. Video camera 216 senses IR light reflected from tabletop objects 206 within its imaging field and produces a digital signal corresponding to images of the reflected IR light. The digital signal is input to processor 202 to enable a location of each tabletop device 206 to be determined. In addition, the size, orientation, and shape of tabletop device 206 may also be determined. Moreover, and as described in greater detail below, a tabletop device 206 may include an IR light reflective pattern or coded identifier that uniquely identifies that particular tabletop device 206 and/or identifies the tabletop device 206 as being within a particular class or group of related tabletop devices 206. Accordingly, the digital signal produced by video camera 216 may also be used to identify a tabletop device 206.

In one embodiment, processor 202 is integral to table 200. In an alternative embodiment, processor 202 is external to table 200 as part of, for example, a server (not shown). As used herein, the term “processor” may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “processor”. In the exemplary embodiment, processor 202 executes algorithms for processing the digital signal from digital video camera 216 and executes software applications that use a user interface functionality of table 200 to display graphic images. The graphic images include, for example, but are not limited to only including, pictures and/or a virtual environment that is visible on display surface 208. As such, table 200 also includes a video projector 222 that displays graphic images, a virtual environment, and/or text information on display surface 208. In one embodiment, video projector 222 is a liquid crystal display (LCD). In an alternative embodiment, video projector 222 is a digital light processor (DLP) display. To facilitate preventing IR light emitted by video projector 222 from entering table 200, wherein the IR light may interfere with the IR light reflected from tabletop devices 206, a filter, such as an IR cut filter 224, is positioned in front of a projector lens (not shown) of video projector 222.

Moreover, in one embodiment, table 200 also includes a plurality of mirror assemblies 236. Specifically, in the exemplary embodiment, a first mirror assembly 226 directs light projected from video projector 222 through an opening 228 defined in frame 204 such that the projected light is incident on a second mirror assembly 230. Second mirror assembly 230 reflects the projected light onto translucent layer 214, which is positioned at a focal point of video projector 222. Table 200 also includes at least one alignment device 232, which is sized to facilitate properly aligning first mirror assembly 226. A positioning device 234 adjusts an angle of second mirror assembly 230. Such devices 232 and 234 facilitate ensuring that the image projected onto display surface 208 is properly aligned with respect to display surface 208. Alternative embodiments may include alternate elements that may be used to align first and second mirror assemblies 226 and 230. Moreover, other alternative embodiments may not include mirror assemblies 236 and/or devices 232 and 234 but, rather, directly project light from video projector 222 onto display surface 208.

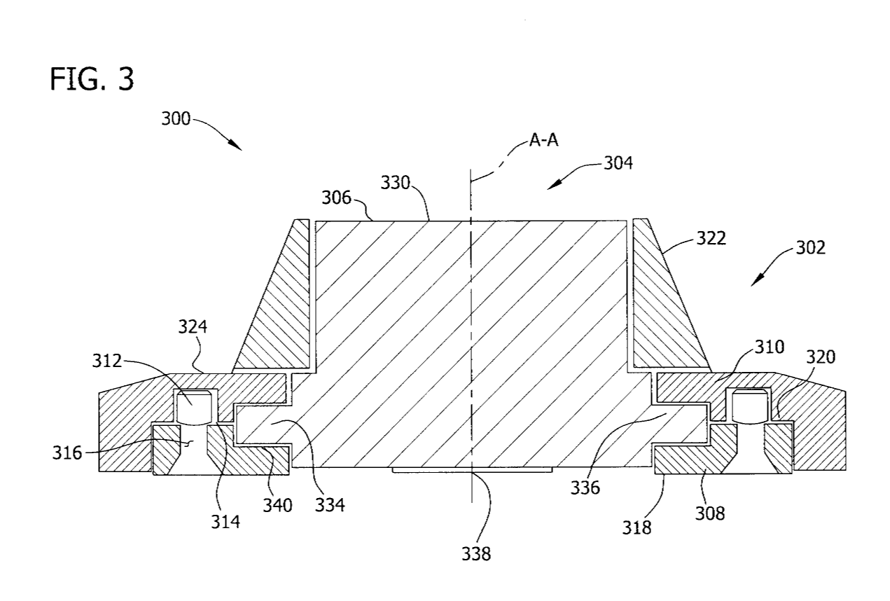

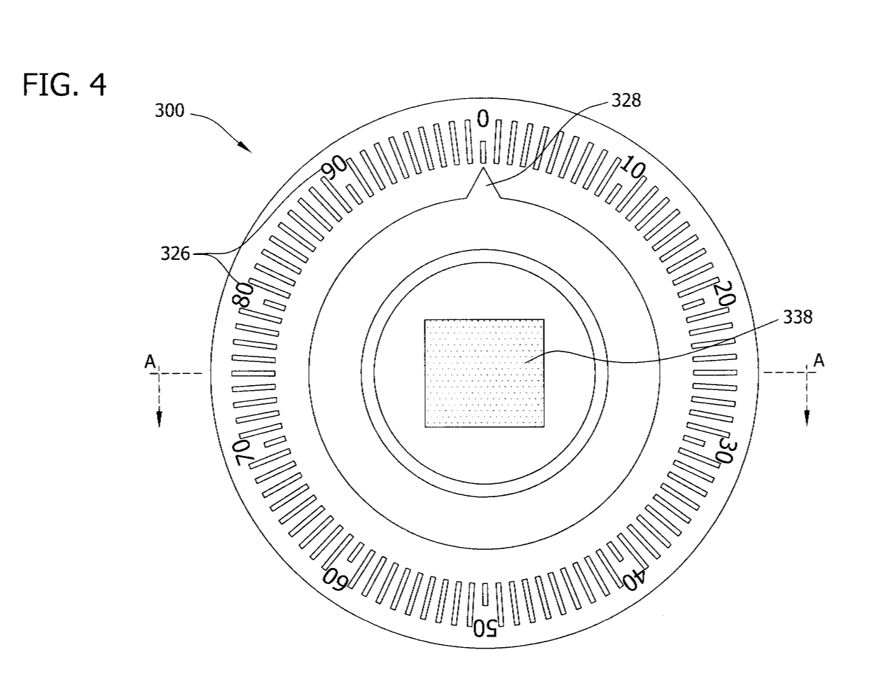

FIG. 3 is a side view of an exemplary gaming device 300 for use with a gaming table, such as table 100 (shown in FIG. 1), or an interactive gaming display table, such as table 200 (shown in FIG. 2). FIG. 4 is a top view of device 300. In the exemplary embodiment, device 300 includes a base 302, a wheel 304, and a display 306. Base 302 includes a first portion 308 and a second portion 310 that is positioned radially outward from first portion 308 with respect to an axis A-A. First and second base portions 308 and 310 are formed from, for example, a gloss black acrylic, and are coupled together via a fastener 312 positioned in a bottom surface 314 of second portion 310 and a coupling mechanism 316 that extends through first portion 308. In the exemplary embodiment, fastener 312 is a nut and coupling mechanism 316 is a threaded screw or bolt. More specifically, in the exemplary embodiment, screw 316 extends through first portion 308 from a bottom surface 318 to a top surface 320 and is sized to be inserted into nut 312 to facilitate securing first portion top surface 320 to second portion bottom surface 314. In alternative embodiments, first and second portions 308 and 310 may be formed from different materials and/or may be coupled together using different methods and/or materials such as, for example, adhesives. Moreover, in the exemplary embodiment, base 302 includes a third portion 322 that is coupled to a top surface 324 of second portion 310. In one embodiment, and as shown in FIG. 4, third portion 322 includes a plurality of markings 326 such as, for example, numbers, that facilitate communicating a current position of wheel 304 to a player. Moreover, in the exemplary embodiment, wheel 304 includes a pointer 328 that facilitates communicating a current position of wheel 304 to the player by aligning with a particular marking 326.

In the exemplary embodiment, wheel 302 includes a top surface 330, an opposing bottom surface 332, a first flange 334, and an opposite second flange 336. First and second flanges 334 and 336 are positioned between top surface 320 of base first portion 308 and bottom surface 314 of base second portion 310. More specifically, in the exemplary embodiment, first and second flanges 334 and 336 are positioned such that wheel 304 is rotatable about axis A-A with respect to base 302. In the exemplary embodiment, wheel 304 is formed from a clear acrylic material. Moreover, in the exemplary embodiment, wheel 304 includes an object tag 338 that is coupled to wheel bottom surface 332 in an orientation that enables object tag 338 to be read by video camera 216 (shown in FIG. 2). Moreover, in one embodiment, wheel flanges 334 and 336 are coupled, such as via a biasing mechanism, to base first portion 308 and base second portion 310 to enable a player to depress wheel top surface 330 to mark a particular wheel position. Accordingly, in such an embodiment, electrical contacts (not shown) are provided on a bottom surface 340 of first flange 334 or second flange 336, or on bottom surface 340 of both first and second flanges 334 and 336 as well as on top surface 320 of base first portion 308. Moreover, in such an embodiment, device 300 may include a memory (not shown) configured to store the position selected by the player.

In another alternative embodiment, wheel 304 includes an encoder ring (not shown). In such an embodiment, base second portion 310 includes a light-emitting diode (LED) (not shown) oriented such that light is emitted towards base first portion 308. Moreover, in such an embodiment, base first portion 308 includes a detector (not shown) that detects light emitted by the LED. The detector determines an angle of rotation of wheel 304 that corresponds to a position of wheel 304. Alternatively, base first portion 308 may include an LED that is oriented to emit light towards base second portion 310, and base second portion 310 may include the detector.

In the exemplary embodiment, display 306 is formed integrally with wheel top surface 330. More specifically, display 306 displays an image to a player that corresponds to a position of wheel 304. In one embodiment, the image is generated by video projector 222 (shown in FIG. 2) and is projected through wheel 304 so as to be displayed to the player by display 306.

In one embodiment, device 300 includes a force feedback device (not shown) that provides feedback, such as haptic feed back and/or audible feedback, to a player as the player rotates wheel 304. For example, for each of unit of rotation, the force feedback device will emit a sound, such as a click sound, and will provide to the player a sensation of resistance and/or tumbler detents associated with locks. The force feedback device may also determine an angle of rotation of wheel 304 by incrementing a count of units of rotation that the player imparts to wheel 304. The force feedback device may be implemented using, for example and not by way of limitation, a PR1000 rotary actuator commercially available from Immersion Corporation, San Jose, Calif.

In an alternative embodiment, device 300 includes a transceiver (not shown). The transceiver communicates with a processor, such as processor 202 (shown in FIG. 2) and/or any alternative processor that is programmed to communicate with the transceiver. More specifically, the transceiver communicates with processor 202 in order to transmit a determined position of wheel 304 and/or receive an image corresponding to the determined position of wheel 304 to be displayed via display 306. The transceiver communicates with processor 202 using a wireless protocol such as, but not limited to, Bluetooth®, Wireless USB®, ZigBee®), and/or a proprietary RF transmission means. (Bluetooth is a registered trademark of Bluetooth SIG, Inc., Bellevue, Wash.; Wireless USB is a registered trademark of Universal Serial Bus Implementers Forum, Inc., Beaverton, Oreg.; ZigBee is a registered trademark of ZigBee Alliance Corp., San Ramon, Calif.).

In another alternative embodiment, device 300 includes a battery (not shown). The battery may be used to power, for example, an LED, a light detector used in conjunction with the LED, and/or a transceiver. In one embodiment, the battery is rechargeable. Accordingly, in such an embodiment, device 300 also includes battery charging contacts (not shown) that are oriented to make contact with a charging dock (not shown).

During operation, in the exemplary embodiment, a player rotates wheel 304 about axis A-A to a selected position by aligning pointer 328 with a selected marking 326 on base third portion 322. In one embodiment, the player then depresses wheel top surface 330 to cause contact between the electrical contacts on bottom surface 340 of first flange 334 and/or second flange 336 and top surface 320 of base first portion 308. The selected position is then stored in a memory and/or transmitted using a transceiver to a processor, such as processor 202. A combination of position selections by the player may correspond to an award. Processor 202 determines the award and transmits an image or an image identifier to the transceiver. An image associated with the position of wheel 304 and/or combination of positions of wheel 304 is then displayed to the player via display 306. In an alternative embodiment, when the player depresses wheel top surface 330, object tag 338 is moved into a position such that object tag 338 is readable by video camera 216, which transmits the position associated with object tag 338 to processor 202. Processor 202 determines the award and causes video projector 222 to project an image through wheel 304 such that the image associated with the position of wheel 304 and/or combination of positions of wheel 304 is displayed to the player via display 306.

In another alternative embodiment, as the player rotates wheel 304, a detector determines an angle of rotation of wheel 304 based on a number of units of rotation. The number of units of rotation is based on a number of LED light emissions counted by the detector and/or shaded by an encoder ring. The angle of rotation is then stored in a memory and/or transmitted using a transceiver to a processor, such as processor 202, and processor 202 determines a position associated with the angle of rotation. A combination of position selections by the player may correspond to an award. Processor 202 determines the award and transmits an image or an image identifier to the transceiver. An image associated with the position of wheel 304 and/or combination of positions of wheel 304 is then displayed to the player via display 306.

In yet another embodiment, a force feedback device (not shown) is coupled to wheel 304 in order to provide haptic and/or aural feedback to the player as the player rotates wheel 304. The force feedback device may also be configured to determine an angle of rotation of wheel 304 based on a number of units of rotation. The number of units of rotation is counted by the force feedback detector and the angle of rotation is then stored in a memory and/or transmitted using a transceiver to a processor, such as processor 202. Processor 202 then determines a position associated with the angle of rotation. A combination of position selections by the player may correspond to an award. Processor 202 determines the award and transmits an image or an image identifier to the transceiver. An image associated with the position of wheel 304 and/or combination of positions of wheel 304 is then displayed to the player via display 306.

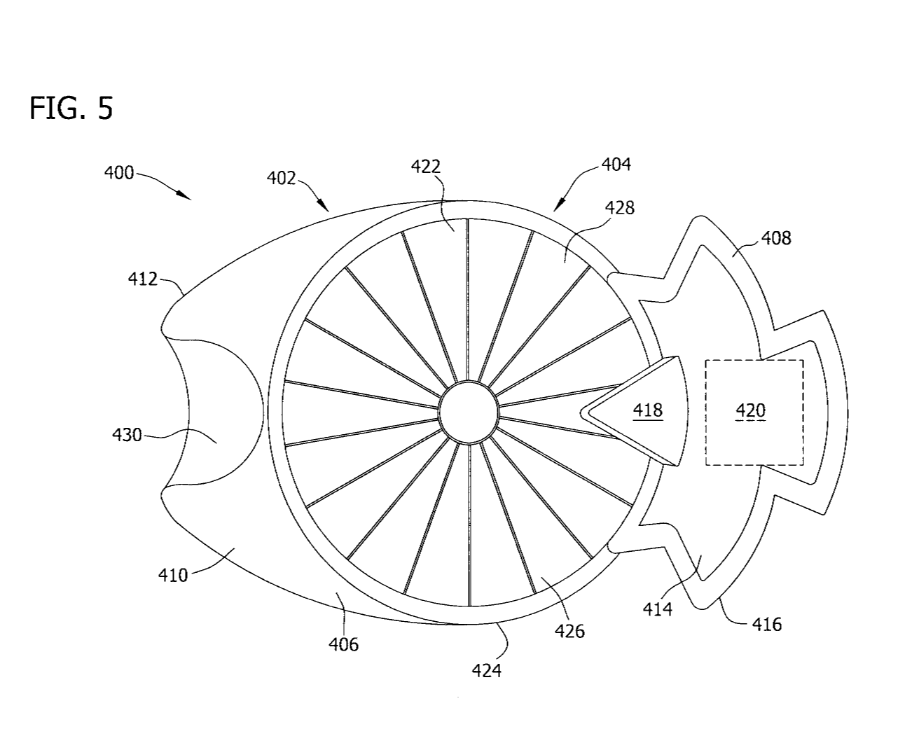

FIG. 5 is a top view of an exemplary gaming device 400 that may be used with a gaming table, such as table 100 (shown in FIG. 1), or an interactive gaming display table, such as table 200 (shown in FIG. 2). In the exemplary embodiment, device 400 includes a base 402 and a wheel 404. Base 402 includes a first portion 406 and a second portion 408. Base first portion 406 includes a top surface 410 and a bottom surface 412, and base second portion 408 includes a top surface 414 and a bottom surface 416. Moreover, base second portion 408 includes a pointer 418 that facilitates communicating a current position of wheel 404 to a player. In one embodiment, base 402 includes an object tag 420 that is coupled to bottom surface 416 of base second portion 408 such that object tag 420 may be read by video camera 216 (shown in FIG. 2).

In the exemplary embodiment, wheel 404 includes a top surface 422, a bottom surface 424, and a plurality of segments 426. A current position of wheel 404 is communicated to the player according to a particular segment 426 being aligned with pointer 418. Moreover, wheel 404 is coupled, such as rotatably coupled, to base 402. In the exemplary embodiment, each segment 426 includes a display 428. More specifically, display 428 displays an image to a player that corresponds to a position of wheel 404. In one embodiment, the image is generated by video projector 222 (shown in FIG. 2) and is projected through wheel 404 so as to be displayed to the player by display 428.

In one embodiment, wheel 404 includes an encoder ring (not shown). In such an embodiment, either base first portion 406 or base second portion 408 includes a light-emitting diode (LED) (not shown) and a detector (not shown) that detects light emitted by the LED. The detector then determines an angle of rotation of wheel 404 that corresponds to a position of wheel 404.

In an alternative embodiment, device 400 includes a transceiver (not shown). The transceiver communicates with a processor, such as processor 202 (shown in FIG. 2) and/or any alternative processor that is configured and/or programmed to communicate with the transceiver. More specifically, the transceiver communicates with processor 202 in order to transmit a determined position of wheel 404 and/or receive an image corresponding to the determined position of wheel 404 to be displayed via display 428. The transceiver communicates with processor 202 using a wireless protocol such as, but not limited to, Bluetooth®, Wireless USB®, ZigBee®, and/or a proprietary RF transmission means.

In another alternative embodiment, device 400 includes a battery (not shown). The battery may be used to power, for example, an LED, a light detector used in conjunction with the LED, and/or a transceiver. In one embodiment, the battery is rechargeable. Accordingly, in such an embodiment, device 400 also includes battery charging contacts (not shown) that are oriented to make contact with a charging dock (not shown).

In one embodiment, base first portion 406 includes a card reader 430 that is positioned between top surface 410 and bottom surface 412. Card reader 430 is configured to read a player tracking card that is inserted by a player prior to rotation of wheel 404. More specifically, the player inserts a player tracking card into card reader 430, which triggers rotation of wheel 404.

During operation, in the exemplary embodiment, wheel 404 rotates to a position such that pointer 418 is aligned with a particular segment 426 on wheel 404. The position is then transmitted using a transceiver to a processor, such as processor 202. A particular position of wheel 404 may correspond to an award. Processor 202 determines the award and transmits an image or an image identifier to the transceiver. An image associated with the position of wheel 404 is then displayed to the player via display 428. In an alternative embodiment, when wheel 404 is finished rotating, object tag 420 is moved into a position such that object tag 420 is readable by video camera 216, which transmits the position associated with object tag 420 to processor 202. Processor 202 determines the award and causes video projector 222 to project an image through wheel 404 such that the image associated with the position of wheel 404 is displayed to the player via display 428.

In another alternative embodiment, wheel 404 rotates, a detector determines an angle of rotation of wheel 404 based on a number of units of rotation. The number of units of rotation is based on a number of LED light emissions counted by the detector and/or shaded by an encoder ring. The angle of rotation is then transmitted using a transceiver to a processor, such as processor 202, and processor 202 determines a position associated with the angle of rotation. A particular position of wheel 404 may correspond to an award. Processor 202 determines the award and transmits an image or an image identifier to the transceiver. An image associated with the position of wheel 404 is then displayed to the player via display 428.

In yet another embodiment, a player inserts a player tracking card into card reader 430 to initiate rotation of wheel 404. Processor 202 determines the award, as described above, and transmits an image or an image identifier to the transceiver. An image associated with the position of wheel 404 is then displayed to the player via display 428.

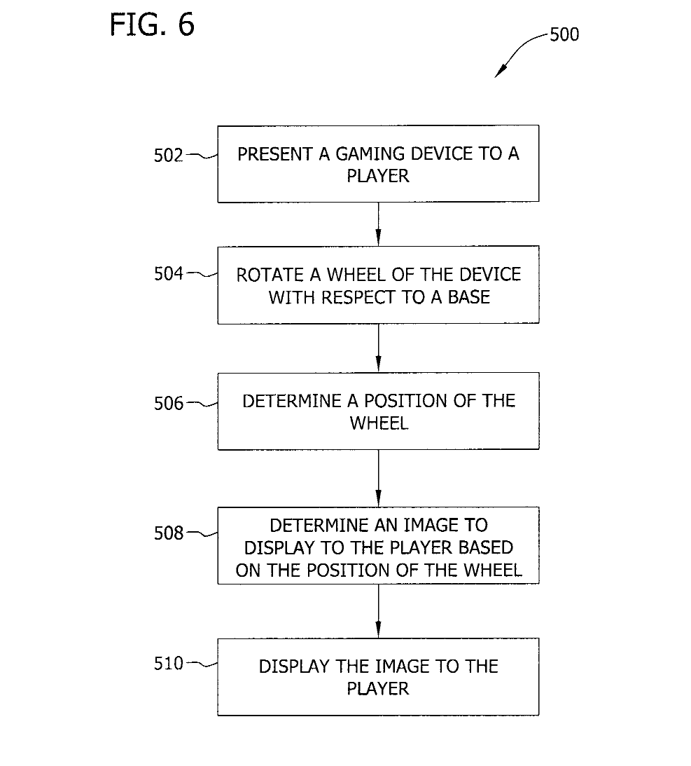

FIG. 6 is a flowchart illustrating an exemplary method 500 for implementing a wheel-based game using a gaming device, such as gaming device 300 (shown in FIGS. 3 and 4) or gaming device 400 (shown in FIG. 5). In the exemplary embodiment, a device 300 and/or 400 is presented 502 to a player. The player may be playing a game at a gaming table such as gaming table 100 or interactive gaming display table 200. Alternatively, in some embodiments, the player may be elsewhere within a casino such as, but not limited to, at a bar, at a restaurant, and/or poolside.

In the exemplary embodiment, and referring to FIGS. 1-5, the player causes a wheel, such as wheel 304 (shown in FIGS. 3 and 4) or wheel 404 (shown in FIG. 5), to rotate 504 relative to a base, such as base 302 (shown in FIGS. 3 and 4) or base 402 (shown in FIG. 5). In one embodiment, the player rotates wheel 304 relative to base 302 to a selected position that is indicated by one of a plurality of markings 326 (shown in FIG. 4) on base 302. The selected position is also indicated by pointer 328 (shown in FIG. 4) on wheel 304. In an alternative embodiment, the player is provided with haptic and/or aural feedback by a force feedback device. In another alternative embodiment, the player activates wheel 404 such that wheel 404 rotates relative to base 402 to a position indicated by one of a plurality of segments 426 (shown in FIG. 5). The position is also indicated by a pointer 418 (shown in FIG. 5) on base 402. In still another alternative embodiment, wheel 404 is actuated through the player's insertion of a player tracking card into card reader 430 (shown in FIG. 5).

In the exemplary embodiment, the position of wheel 304 or wheel 404 is determined 506. In one embodiment, the player depresses wheel 304, which causes contact between electrical contacts coupled to wheel 304 and base 302. The selected position is then stored in a memory and/or transmitted using a transceiver to a processor, such as processor 202 (shown in FIG. 2). A combination of position selections by the player may correspond to an award. In an alternative embodiment, when the player depresses wheel 302, object tag 338 is moved into a position such that object tag 338 is readable by video camera 216 (shown in FIG. 2), which transmits the position associated with object tag 338 to processor 202. Alternatively, as wheel 404 stops rotating, object tag 420 is positioned such that object tag 420 may be read by video camera 216, which transmits the position associated with object tag 420 to processor 202. In another alternative embodiment, as the player rotates wheel 304, a detector determines an angle of rotation of wheel 304 or wheel 404 based on a number of units of rotation. The number of units of rotation is based on a number of LED light emissions counted by the detector and/or shaded by an encoder ring. The angle of rotation is then stored in a memory and/or transmitted using a transceiver to processor 202, and processor 202 determines a position associated with the angle of rotation. In another alternative embodiment, a force feedback device may be configured to determine an angle of rotation of wheel 304 based on a number of units of rotation. The number of units of rotation is counted by the force feedback detector and the angle of rotation is then stored in a memory and/or transmitted using a transceiver to a processor, such as processor 202. Processor 202 then determines a position associated with the angle of rotation.

In the exemplary embodiment, an image to be displayed is determined 508 based on the determined wheel position or combination of positions. In one embodiment, an image associated with the position of wheel 304 and/or wheel 404 and/or a combination of positions of wheel 304 is determined according to one or more positions stored in a memory and/or transmitted to processor 202. In an alternative embodiment, processor 202 determines the award based on a position and/or orientation of object tag 338 and/or object tag 420 that is detected by video camera 216. In another embodiment, processor 202 determines the award based on a position of wheel 304 and/or wheel 404 that is determined by an angle of rotation. The angle of rotation may be determined by an LED that emits light through an encoder ring which is then detected by a detector and transmitted to processor 202. Alternatively, the angle of rotation may be determined by a number of units of rotation through which wheel 304 is rotated, wherein the number of units is counted by a force feedback device.

In the exemplary embodiment, the image is then displayed 510 to the player. In one embodiment, processor 202 causes video projector 222 (shown in FIG. 2) to project the image through wheel 304 and/or wheel 404 such that the image associated with the position of wheel 304 and/or wheel 404 and/or combination of positions of wheel 304 is displayed to the player via display 306 and/or display 428. In an alternative embodiment, display 306 and/or display 428 may display the image stored in a memory.

The apparatus and methods described herein facilitate providing game players with a portable gaming device to increase playing time and/or the players' willingness to try to obtain a bonus game. Providing a portable and/or table top gaming device facilitates greater player enjoyment by enabling the player to interact with a physical device rather than with an electronic image. Enabling the player to interact with a physical device facilitates providing the player with a sense of being able to control the outcome of the game or bonus game played using the device, regardless of the actual methodology of determining the result.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

Although the apparatus and methods described herein are described in the context of a bonus device for use with a gaming table, it is understood that the apparatus and methods are not limited to bonus devices or gaming tables. Likewise, the apparatus components illustrated are not limited to the specific embodiments herein, but rather, components of the apparatus can be utilized independently and separately from other components described herein.

While the above-described embodiments have been described in terms of various specific embodiments, those skilled in the art will recognize that the above-described embodiments may be practiced with modification within the spirit and scope of the claims.

What is claimed is:

1. A portable gaming device, comprising:
a base;
a user-actuated wheel coupled to said base such that said wheel is rotatable relative to said base; and
a display configured to display an image corresponding to a position of said wheel to a player.

2. A portable gaming device in accordance with claim 1, wherein said base comprises an indicator for indicating the position of said wheel relative to said base.

3. A portable gaming device in accordance with claim 1, wherein said base comprises an encoder ring and an LED.

4. A portable gaming device in accordance with claim 3, further comprising a detector configured to determine the position of said wheel based on a number of positions through which said wheel is rotated by the player.

5. A portable gaming device in accordance with claim 1, wherein said wheel comprises at least one object tag capable of being read by a remote camera to determine the position of said wheel.

6. A portable gaming device in accordance with claim 1, wherein said wheel comprises an indicator for indicating the position of said wheel relative to said base.

7. A portable gaming device in accordance with claim 1, wherein said display is configured to display the image corresponding to the position of said wheel as the image is projected through said wheel by a remote projector.

8. A portable gaming device in accordance with claim 1, further comprising a force feedback device coupled to said wheel, said force feedback device is configured to provide haptic feedback to the player representative of movement of said wheel by the player.

9. A portable gaming device in accordance with claim 8, wherein said force feedback device is configured to determine a position of said wheel by counting a number of positions through which said wheel is rotated by the player.

10. A portable gaming device in accordance with claim 1, further comprising a wireless transceiver configured to transmit the position of said wheel to a remote processor.

11. A portable gaming device in accordance with claim 10, wherein said transceiver is configured to receive the image corresponding to the position of said wheel from the remote processor and to transmit the received image to said display.

12. A portable gaming device in accordance with claim 1, further comprising a battery.

13. A portable gaming device in accordance with claim 12, wherein said battery is rechargeable.

14. A portable gaming device in accordance with claim 1, further comprising a card reader configured to read a card inserted by the player, wherein the position of said wheel is associated with contents of the card.

15. A method of game play using a portable gaming device, said method comprising:
presenting the gaming device to a player;
rotating a wheel coupled to a stationary base;
determining a position of the wheel; and
displaying an image to the player corresponding to the position of the wheel.

16. A method in accordance with claim 15, further comprising indicating the position of the wheel to the player using a position indicator.

17. A method in accordance with claim 15, wherein determining a position of the wheel comprises reading at least one object tag coupled to a bottom surface of the wheel.

18. A method in accordance with claim 15, wherein determining a position of the wheel comprises:
rotating an encoder ring in conjunction with the wheel; and
detecting an angle of rotation of the wheel based on a number of positions through which the wheel is rotated.

19. A method in accordance with claim 15, wherein displaying an image to the player corresponding to the position of the wheel comprises projecting the image through the wheel using a remote projector.

20. A method in accordance with claim 15, further comprising providing haptic feedback to the player representative of movement of the wheel by the player.

21. A method in accordance with claim 20, wherein determining a position of the wheel comprises counting a number of positions through which the wheel is rotated.

22. A method in accordance with claim 15, further comprising transmitting a signal representative of the position of the wheel to a remote processor.

23. A method in accordance with claim 22, further comprising receiving from the remote processor a signal representative of the image to be displayed.

24. A method in accordance with claim 15, further comprising powering the gaming device using a battery.

25. A method in accordance with claim 15, further comprising reading a card inserted into the gaming device, wherein the card includes information related to the image to be displayed.

26. A method in accordance with claim 15, wherein displaying an image to the player corresponding to the position of the wheel comprises displaying a number.

27. An apparatus for implementing a wheel-based bonus game, said apparatus comprising:
a base;
a wheel coupled to said base such that said wheel is rotatable relative to said base;
an indicator for indicating a position of said wheel relative to said base; and
a display configured to display an image to a player corresponding to the position of said wheel.

28. An apparatus in accordance with claim 27, wherein the position of said wheel is determined by reading at least one object tag coupled to a bottom surface of said wheel.

29. An apparatus in accordance with claim 27, wherein the position of said wheel is determined by rotating an encoder ring in conjunction with said wheel and detecting an angle of rotation of said wheel based on a number of positions through which said wheel is rotated.

30. An apparatus in accordance with claim 27, wherein the image is displayed to the player by projecting the image through said wheel using a remote projector.

31. An apparatus in accordance with claim 27, further comprising a force feedback device configured to provide haptic feedback to the player representative of movement of said wheel by the player.

32. An apparatus in accordance with claim 31, wherein the position of said wheel is determined according to an angle of rotation of the wheel calculated by said force feedback device.

33. An apparatus in accordance with claim 27, further comprising a transceiver configured to transmit a signal representative of the position of said wheel to a remote processor.

34. An apparatus in accordance with claim 33, wherein said transceiver is configured to receive from the remote processor a signal representative of the image to be displayed.

35. An apparatus in accordance with claim 27, further comprising a card reader configured to read information related to the image to be displayed from a player card.

36. An apparatus in accordance with claim 27, wherein the image to be displayed to the player corresponding to the position of the wheel is a number.
